(19) United States
(12) Patent Application Publication
(10) Pub. No.: US 2010/0283893 A1
(43) Pub. Date: Nov. 11, 2010

(54) PROCESSING INTERLACED VIDEO OVER DSI

(76) Inventors: Jingjiang YIN, Jamestown, NC (US); Rod MILLER, Kernersville, NC (US)

Correspondence Address: KENYON & KENYON LLP, 1500 K STREET, NW, WASHINGTON, DC, 20005-1257, US

(21) Appl. No.: 12/473,476

(22) Filed: May 28, 2009

Related U.S. Application Data
(60) Provisional application No. 61/177,170, filed on May 11, 2009.

(51) Int. Cl. H04N 7/01; H04N 7/12

(52) U.S. Cl. 348/441; 375/240.25; 375/E07.027; 348/E07.003

(57) ABSTRACT

Multiple systems and methods for accurately regenerating interlaced video signals that are transmitted using DSI is provided. In some embodiments, multiple types of VSYNC packets may be defined and used in encoding packets depending when the edge of a VSYNC pulse does or does not coincide with the start of a HSYNC pulse. These types of VSYNC packets may be distinguished in some embodiments by either create new VSYNC packet types, or encoding unused bits in existing DSI packets. In other embodiments, a filter may be used to detect and correct HSYNC frequency distortions caused during the regeneration of interlaced video signals decoded from DSI packets.

### REFERENCE TO RELATED APPLICATIONS

This application claims priority to U.S. Provisional Application No. 61/177,170, filed May 11, 2009, the contents of which are incorporated herein by reference in its entirety.

### BACKGROUND

Demand for mobile electronic devices with additional functionality at lower prices continues to remain strong. Users are seeking devices that offer more features, such as high-resolution video playback, for less money. Manufacturers, in turn, are improving efficiencies and reducing costs associated with the manufacturing process. For example, the Mobile Industry Processor Interface Alliance has established the Display Serial Interface (DSI) specification to reduce the cost of display sub-systems in mobile devices. While DSI has reduced the cost of display sub-systems, DSI only supports the transmission of progressive video and not interlaced video.

Progressive video includes the full information of a video scene in each video frame. FIG. 1 shows exemplary wave forms of HSYNC and VSYNC signals over time in progressive video. HSYNC signals control the start and end of a line of video on a display, and VSYNC signal pulses control the start and end of a screen or frame. At time 10 the HSYNC pulses starts, and remains active until time 11, when the HSYNC pulse ends. Between times 11 and 13, both the HSYNC and VSYNC signals are relatively inactive. At time 13, both the HSYNC and VSYNC pulses start. The HSYNC pulse remains active until time 14. Between times 14 and 15, only the VSYNC pulse remains active. At time 15, the HSYNC pulse starts again, and both pulses remain active until time 16, when the HSYNC pulse ends. Between times 16 and 18, only the VSYNC pulse remains active, and at time 18, the VSYNC pulse ends and the HSYNC pulse starts. Between times 18 and 19, only the HSYNC pulse is active, and time 19, the HSYNC pulse ends.

Because each video frame in progressive video includes the full information of a video scene, the start of VSYNC pulse in progressive video always coincides with the start of a HSYNC pulse, as shown, for example, at time 13. For the same reason, the end of a VSYNC pulse also always coincides with the start of a HSYNC pulse, as shown, for example, at time 18. Interlaced video, however, does not include the full information of a video scene in each video frame.

Instead, interlaced video splits the information in a video scene between two adjacent video frames. Because information in a video scene is split between two frames in interlaced video, there are two types of transitions between the frames, which we will designate as type A and type B. FIG. 2 shows the relationship between the HSYNC and VSYNC transitions over time in frame types A and B. The HSYNC and VSYNC transitions in interlaced video frame type A are identical to the transitions in progressive video shown in FIG. 1. In both cases, the VSYNC start at time 13 and the VSYNC end at time 18 coincide with the start of an HSYNC pulse.

However, in frame type B, the VSYNC pulse start and VSYNC pulse end do not coincide with HSYNC pulse starts. Instead, the VSYNC pulse starts at time 12, which is halfway between the end of the HSYNC pulse at time 11 and the start of the HSYNC pulse at time 13. Similarly, the VSYNC pulse ends at time 17, which is also halfway between the end of the HSYNC pulse at time 16 and the start of the HSYNC pulse at time 18. It is the disconnect between the start of the HSYNC and VSYNC pulses in frame type B that prevents DSI from transmitting interlaced video, as explained in the following paragraphs.

FIG. 3 shows the HSYNC and VSYNC signals over time for frame type B as shown in FIG. 2 and also shows the encoded DSI packets corresponding to these HSYNC and VSYNC signals. During the encoding process, the starts and ends of HSYNC and VSYNC pulses are recorded in DSI packets. For example, an HSYNC start (HSS) packet may be generated corresponding to the start of the HSYNC pulse at time 10. One or more HSYNC active (HSA) packets may then follow the HSS packet until an HSYNC end (HSE) packet is added corresponding to the end of the HSYNC pulse at time 11. After the HSE packet is added, additional packets (BLLP) may be added depending on the resolution of the video. A VSYNC start (VSS) packet may then be added corresponding to the start of the VSYNC pulse at time 12. Additional BBLP packet(s) may then be added, which may be further followed by a HSS packet corresponding to the start of the HSYNC pulse at time 13. Additional HSA packet(s) may then added, which may be further followed by an HSE packet corresponding to the HSYNC pulse end at time 14. This may be followed by additional BLLP packets and a HSS packet corresponding to the start of the HSYNC pulse at time 15. This may be followed by additional HSA packet(s) and a HSE packet corresponding to the end of the HSYNC pulse at time 16. Following this may be additional BLLP packet(s) and a VSYNC end (VSE) packet corresponding to the end of the VSYNC pulse at time 17. This may be followed by additional BLLP packet(s) and a HSS packet corresponding to the start of the HSYNC pulse at time 18. This may be followed by additional HSA packet(s) and a HSE packet corresponding to the end of the HSYNC pulse at time 19.

Once these signals have encoded in DSI packets and transmitted, they are subsequently decoded at a receiver. Since the DSI format is designed to be used with progressive video, in which both the start and end of a VSYNC pulse coincides with the start of an HSYNC pulse as previously discussed, the DSI format specifies that each VSYNC start (VSS) packet represents the start of both a VSYNC pulse and a HSYNC pulse, and each VSYNC end (VSE) packet represented the end of a VSYNC pulse and the start of a HSYNC pulse. FIG. 4 shows the waveforms over time of the HSYNC and VSYNC signals decoded from the DSI packets shown in FIG. 3.

As the receiver begins decoding the packets, it may decode the first packet shown in FIG. 3, a HSS packet, and generate the start of a HSYNC pulse at time 10. The HSYNC pulse may continue to be active until time 11 is reached, when the HSE packet indicates the end of the HSYNC pulse. Later, the VSS packet, which indicates the start of both a VSYNC pulse and a HSYNC pulse, as discussed in the previous paragraph, may be decoded leading to the start of both a VSYNC and HSYNC pulse at time 12. The HSYNC pulse will continue to remain active until a HSE packet is processed. However, the next HSE packet following the VSS packet was encoded to indicate the end of the HSYNC pulse at time 14, so the HSYNC pulse will continue to remain active until time 14. The problem with this decoding is that the second HSYNC pulse becomes active for an additional time, from time 12 to time 13, as indicated by the hatched lines showing error region 41 of the decoded HSYNC wave function. As shown in the FIG. 3, the second HSYNC pulse is only supposed to be active between times 13 and 14; between times 12 and 13 the HSYNC pulse is supposed to be inactive.

A similar problem, as shown by the hatched lines showing error region 42, occurs when the VSE packet is decoded, since, as previously discussed, a VSE packet indicated both the end of a VSYNC pulse and the start of a HSYNC pulse. When the VSE packet is decoded, the VSYNC pulse will be ended at time 17, and an HSYNC pulse will also be started at time 17. The HSYNC pulse will continue to be active until the next HSE packet is processed. Since the next HSE packet after the VSE packet does not indicate ending the HSYNC pulse until time 19, the HSYNC pulse will remain active until time 19. The similar problem with this decoding is that the fourth HSYNC pulse becomes active for an additional time, from time 17 to time 18, as indicated by the hatched lines showing error region 42 of the decoded HSYNC wave function. As shown in the FIG. 3, the fourth HSYNC pulse is only supposed to be active between times 18 and 19; between times 17 and 18 the HSYNC pulse is supposed to be inactive. These errors may result in interlaced videos that are visually distorted and/or unviewable.

Because there are many systems and display devices using interlaced video, there is a need to be able to transmit and/or receive interlaced video using DSI without distortions or errors.

### BRIEF DESCRIPTION OF THE DRAWINGS

FIG. 1 shows exemplary wave forms of HSYNC and VSYNC signals over time in progressive video.

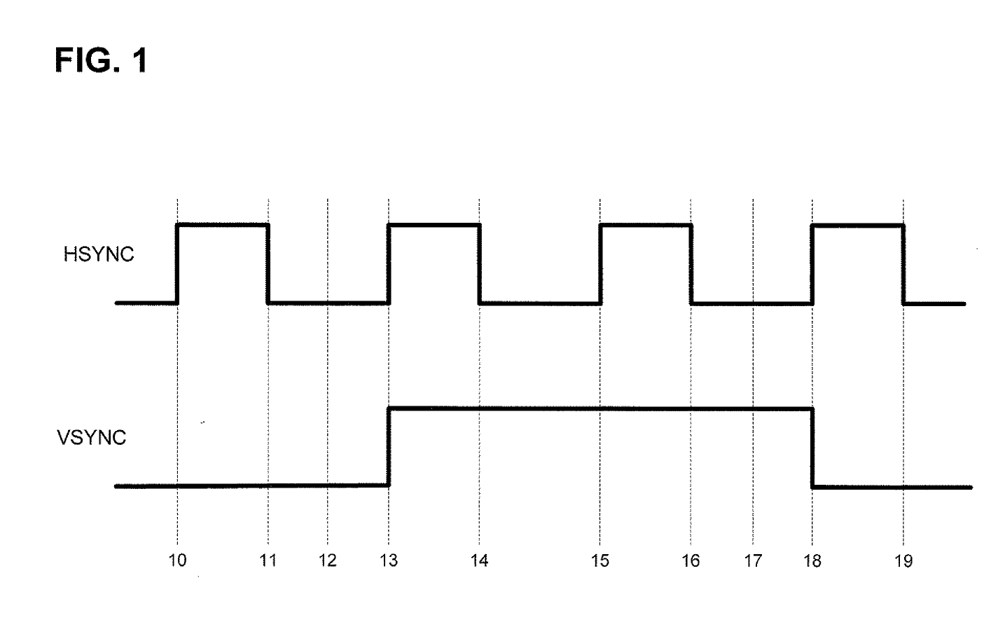

FIG. 2 shows the relationship between the HSYNC and VSYNC transitions over time for frame types A and B in interlaced video.

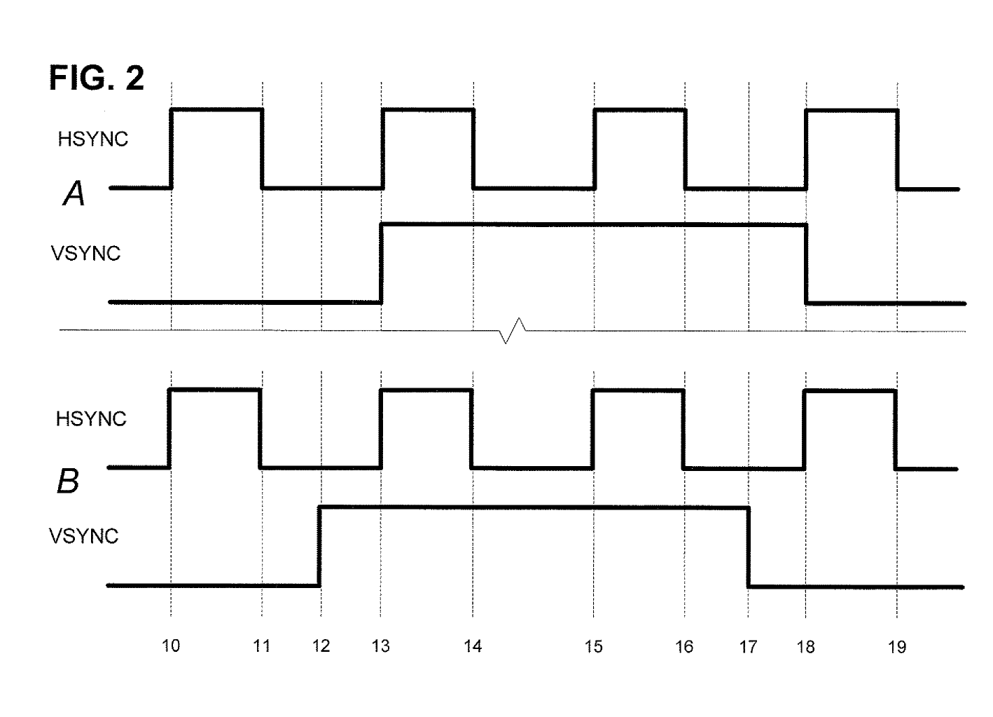

FIG. 3 shows the HSYNC and VSYNC signals over time for interlaced video frame type B in FIG. 2 and also shows the encoded DSI packets corresponding to these HSYNC and VSYNC signals.

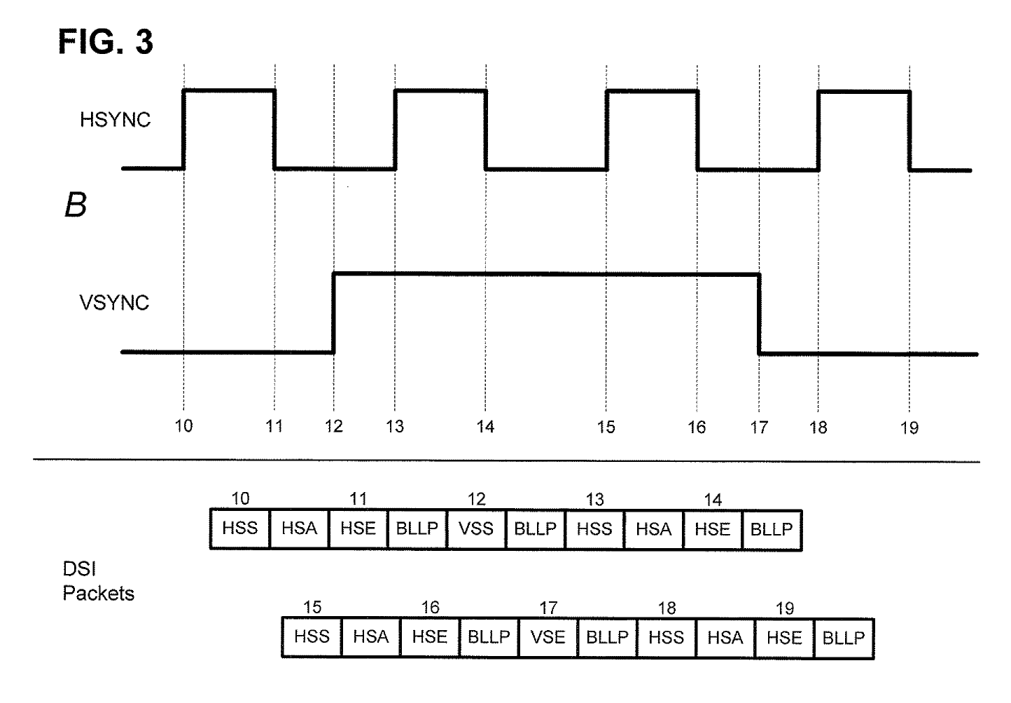

FIG. 4 shows the waveforms over time of the HSYNC and VSYNC signals decoded from the DSI packets shown in FIG. 3.

FIG. 5 shows the HSYNC and VSYNC waveforms of a first interlaced video frame type A and the corresponding encoded DSI packets in an embodiment.

FIG. 6 shows the HSYNC and VSYNC waveforms of the second interlaced video frame type B and the corresponding encoded DSI packets in an embodiment.

FIG. 7 shows a method for encoding DSI packets using existing DSI packets and new VSYNC packets in an embodiment.

FIG. 8 shows a method for decoding DSI packets containing existing DSI packets and new VSYNC packets in an embodiment.

FIG. 9 shows a method for encoding DSI packets to identifying whether the start or end of a VSYNC pulse coincides with the start of an HSYNC pulse in an embodiment.

FIG. 9a shows a DSI transmitter comprising a DSI encoder to encode packets according to the methods shown in FIGS. 7 and/or 9.

FIG. 10 shows a method for decoding modified DSI packets to determine whether the start or end of a VSYNC pulse coincides with the start of a HSYNC pulse in an embodiment.

FIG. 11 shows an embodiment using a filter to restore the correct HSYNC waveform.

FIG. 12 shows an embodiment using a converter containing the filter shown in FIG. 11 to convert DSI video input(s) to interlaced video output(s) in different formats.

FIG. 13 shows embodiments where a filter is used to regenerate interlaced video signals from DSI packets in different electronic devices.

### DETAILED DESCRIPTION

Multiple embodiments for accurately regenerating HSYNC waveforms when interlaced video signals are transmitted using DSI are provided. In some embodiments, VSYNC packets may be defined to be of multiple types—a first type may indicate that the VSYNC event coincides with an HSYNC pulse and a second type may indicate that the VSYNC event does not coincide with the start of a HSYNC pulse. In other embodiments, a filter may be used to detect and correct HSYNC frequency distortions caused during the regeneration of interlaced video signals decoded from DSI packets.

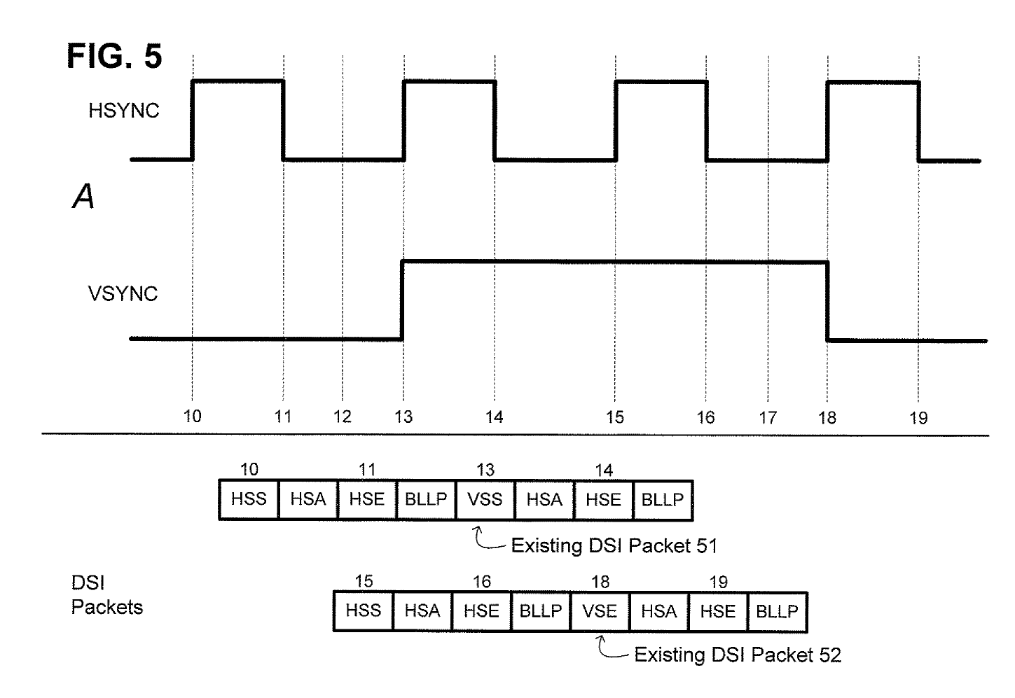

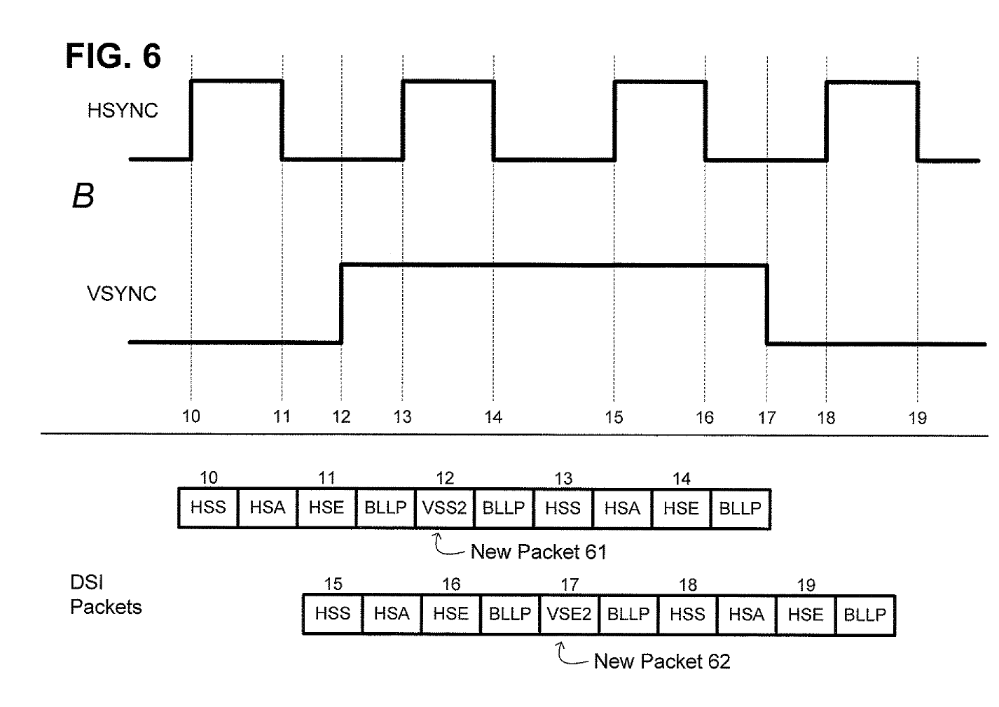

FIGS. 5 and 6 show the HSYNC and VSYNC waveforms and corresponding encoded DSI packets for the two types of VSYNC packets in an embodiment of the invention. The upper portion of FIG. 5 shows an example of HSYNC and VSYNC waveforms over time corresponding to the first type of VSYNC packets, type “A”, whereas the upper portion of FIG. 6 shows the HSYNC and VSYNC waveforms over time corresponding to the second type of VSYNC packets, type “B”. While the HSYNC and VSYNC waveforms in other embodiments may vary from those shown in FIGS. 5 and 6, the main idea of the edge of a VSYNC pulse coinciding with the edge of an HSYNC pulse in frame type “A”, whereas the edge of a VSYNC pulse does not coincide with the edge of a HSYNC pulse in frame type “B”, may remain the same in the other embodiments.

The bottom portion of FIG. 5 shows the encoded DSI packets, including the type “A” VSYNC packets VSS 51 and VSE 51, corresponding to the HSYNC and VSYNC waveforms shown in the upper portion of FIG. 5. For type “A” packets, the packets may be encoded pursuant to the existing DSI specification, so the DSI packets corresponding to the start of the VSYNC pulse at time 13 may be encoded using the existing VSYNC start (VSS) packet 51, and the DSI packets corresponding to the end of the VSYNC pulse at time 18 may also be encoded using the existing VSYNC end (VSE) packet 52. When it is time to decode the existing VSS packet 51, both a VSYNC pulse and a HSYNC pulse will be started. Similarly, when the existing VSE packet 52 is subsequently decoded, the VSYNC pulse will be ended and a new HSYNC pulse will be started. Since the start and end of a VSYNC pulse both coincide with the start of a HSYNC pulse in frame type A, the resulting regenerated waveform will be correct and there will be no distortion or error.

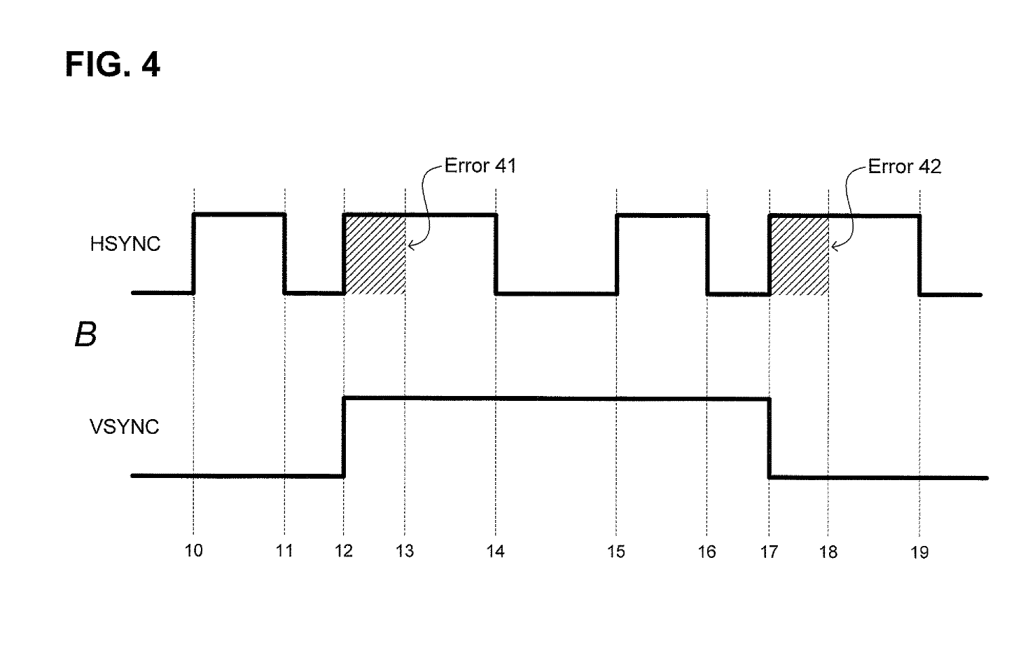

The bottom portion of FIG. 6 shows the encoded DSI packets, including the type “B” VSYNC packets VSS2 61 and VSE2 62, corresponding to the HSYNC and VSYNC waveforms shown in the upper portion of FIG. 6. For type “B” packets, new packet types VSS2 61 and VSE2 62 may be created. The new VSS2 packets 61 may be defined to only correspond to a VSYNC start pulse, so that when the new VSS2 packet 61 is decoded, a VSYNC pulse is started with no change to the HSYNC waveform. Similarly, the new VSE2 packets 62 may be defined to only correspond to a VSYNC end pulse, so that when the new VSE2 packet 62 is decoded, a VSYNC pulse is ended with no change to the HSYNC waveform. Using the VSS2 and VSE2 packets when encoding waveforms similar to those shown in the upper portion of FIG. 6 will eliminate the premature HSYNC pulse starts and error regions 41 and 42 shown in FIG. 4. As a result, the regenerated waveform will mirror the waveform shown in the top portion of FIG. 6 and there will be no distortion or error when decoding the packets using the new definition for these packets. Since there will be no distortion or error in either frame type, the interlaced video as a whole will also contain no distortion or error.

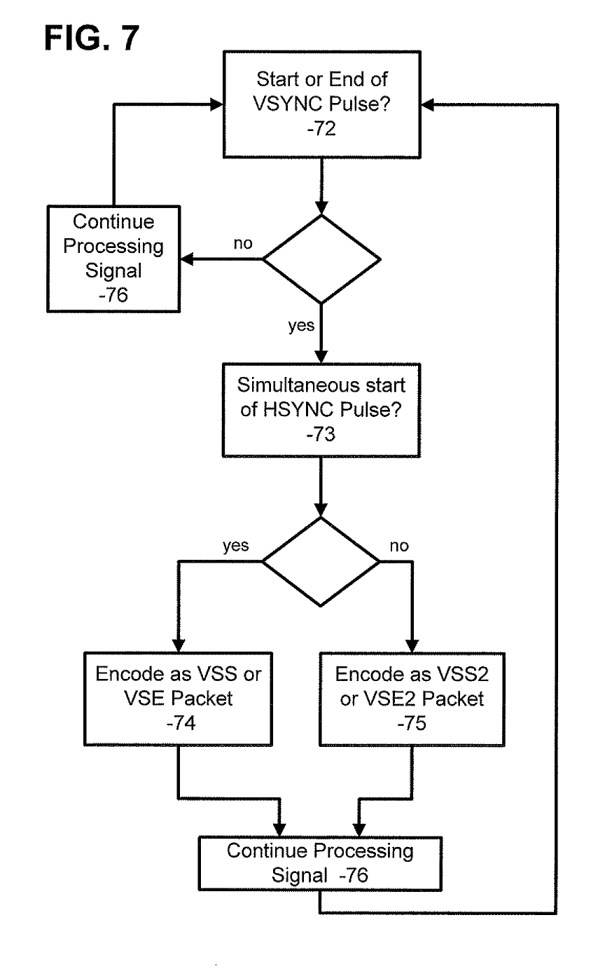

FIG. 7 shows a method in an embodiment for encoding DSI packets using multiple types of VSYNC packets—the first type “A” being existing VSYNC DSI packets and the second type “B” being new VSS2 and VSE2 packets. While processing an interlaced video signal and encoding the signal in DSI packets, an embodiment may check the vertical synchronization (VSYNC) signal to identify if the portion of signal being processed represents the edge of a VSYNC pulse on the VSYNC signal, as shown in step 72.

When the portion of the signal being processed does not represent the edge of a VSYNC pulse, the signal processing may continue as indicated in step 76 and packets may continue to be generated according to DSI specifications. This process may repeat until the signal portion being processed represents the start or end of a VSYNC pulse.

When the signal portion being processed represents the edge of a VSYNC pulse, an embodiment may also check whether the edge of the VSYNC pulse coincides with the edge of a HSYNC pulse on the horizontal synchronization (HSYNC) signal, as indicated in step 73.

When the edge of a VSYNC pulse coincides with the edge of a HSYNC pulse, a VSS packet 51 or VSE packet 52 may be generated or encoded according to DSI specifications depending on whether the portion of the VSYNC signal being processed represents the start edge (VSS) or end edge (VSE) of the VSYNC pulse, as indicated in step 74.

When the edge of a VSYNC pulse does not coincide with the edge of a HSYNC pulse, a VSS2 packet 61 or a VSE2 packet 62 may be generated or encoded depending on whether the portion of the VSYNC signal being processed represents the start edge (VSS2) or end edge (VSE2) of the VSYNC pulse, as indicated in step 75.

Once the appropriate packet has been generated or encoded, the signal processing/encoding procedure may continue as indicated in step 76 by returning to step 72 to continue processing/encoding the video signal into DSI packets.

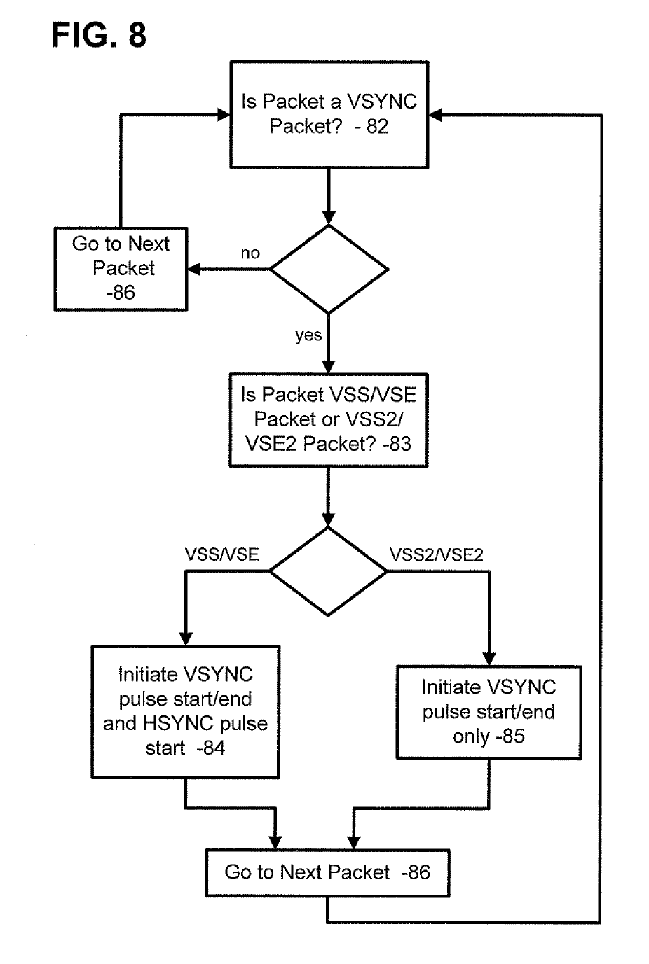

FIG. 8 shows a method in an embodiment for decoding modified DSI packets to determine whether the start or end of a VSYNC pulse coincides with the start of a HSYNC pulse. During packet decoding process, an embodiment in step 82 may check whether the packet being decoded is a VSYNC packet, such as a VSS, VSE, VSS2, or VSE2 packet.

If the packet is not a VSYNC packet, the packet may be decoded according to DSI specifications and an embodiment may move on to the next packet, as shown in step 86, returning to step 82 to check if the next packet is a VSYNC packet.

When a packet is a VSYNC packet, such as a VSS, VSE, VSS2, or VSE2 packet, the packet may be further analyzed to check the type of packet, such as whether the VSYNC packet is an existing DSI VSYNC packet—VSS packet 51 or a VSE packet 52—or whether the VSYNC packet is a new packet—VSS2 packet 61 or a VSE2 packet 62—as shown in step 83.

When the VSYNC packet is of the first type, such as a VSS packet 51 or a VSE packet 52, the VSYNC packet may be decoded according to DSI specifications; in the case of a VSS packet 51, both a VSYNC pulse and a HSYNC pulse may be started simultaneously, while in the case of a VSE packet 52, a VSYNC pulse may be ended simultaneously with the start of a new HSYNC pulse, as shown in step 84.

When the VSYNC packet is of the second type, such as a VSS2 packet 61 or a VSE2 packet 62, the VSYNC packet may be further analyzed to determine whether it is a VSS2 packet 61 or VSE2 packet 62. When the VSYNC packet is a VSS2 packet 61, a VSYNC pulse may be started without any change to the HSYNC waveform and when the VSYNC packet is a VSE2 packet 62, a VSYNC pulse may be ended without any change to the HSYNC waveform, as shown in step 85.

In step 86, an embodiment may move on to the process of decoding the next packet, returning to step 82 to check if the next packet is a VSYNC packet.

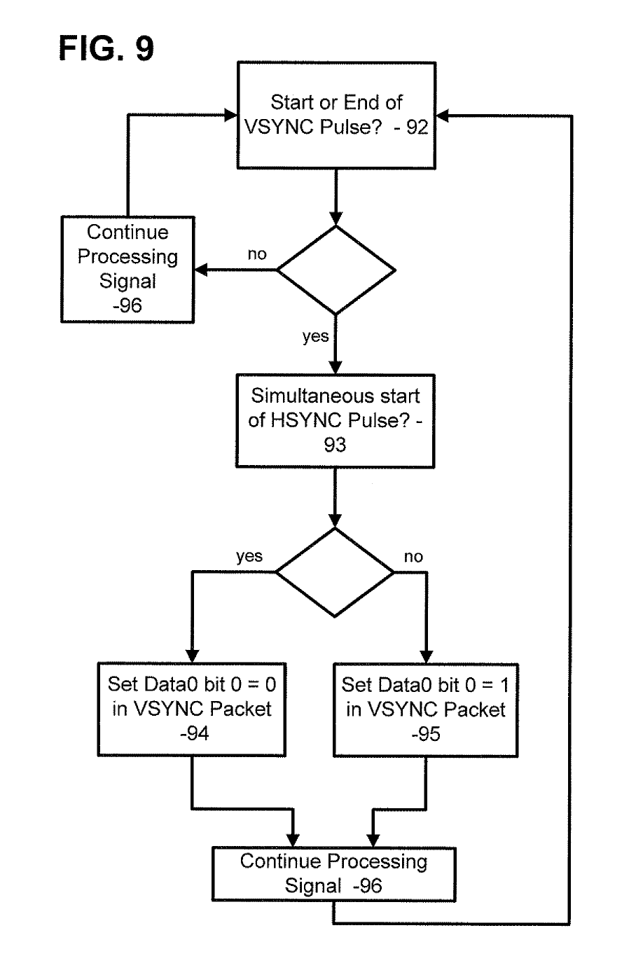

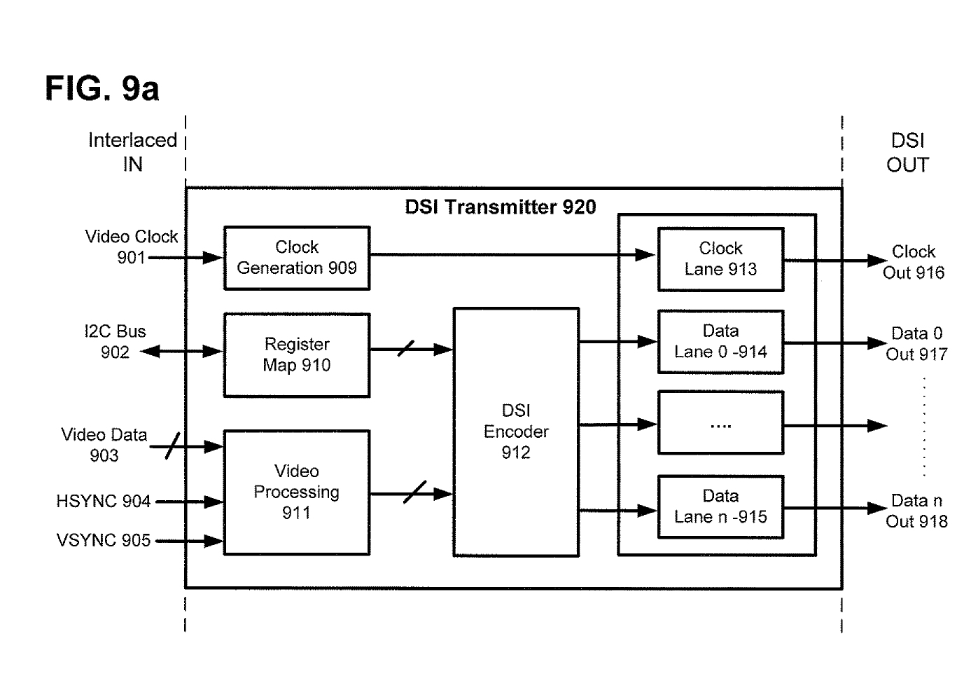

Other embodiments may take a slightly different approach. For example, instead of creating a new type of VSYNC packet, such as type “B” packets, other embodiments may identify whether the edge of a VSYNC pulse coincides with the edge of a HSYNC pulse by encoding unused bits in DSI packets. FIG. 9 shows an embodiment for encoding unused bits in DSI packets to identifying whether the edge of a VSYNC pulse coincides with the edge of an HSYNC pulse.

While processing an interlaced video signal and encoding the signal in DSI packets, an embodiment may check the vertical synchronization (VSYNC) signal to identify if the portion of signal being processed represents the edge of a VSYNC pulse on the VSYNC signal, as shown in step 92.

When the portion of the signal being processed does not represent the edge of a VSYNC pulse, the signal processing may continue as indicated in step 96 and packets may continue to be generated according to DSI specifications. This process may repeat until the signal portion being processed represents the edge of a VSYNC pulse.

When the signal portion being processed represents the edge of a VSYNC pulse, an embodiment may also check whether the edge of the VSYNC pulse coincides with the edge of a HSYNC pulse on the horizontal synchronization (HSYNC) signal, as indicated in step 93.

When the start of a HSYNC pulse coincides with the edge of a VSYNC pulse, a value may be assigned to unused bit(s) in either the VSS or VSE packet, depending on whether the VSYNC signal represents the edge of a VSYNC pulse. An unused bit is either a bit that is undefined, unassigned, or not used by DSI specifications, or a bit whose value can be changed without materially affecting video quality. A different value may then be assigned to the same unused bit when the start of the HSYNC pulse does not coincide with the edge of the VSYNC pulse.

For example, in step 94 of an embodiment, the unused Data0 bit 0 in a VSYNC packet (VSS or VSE, depending on whether the signal represents the start edge (VSS) or end edge (VSE) of a VSYNC pulse) may be set to 0 when the start edge of a HSYNC pulse coincides with the respective edge of a VSYNC pulse; in step 95 of an embodiment, the same unused bit may be set to 1 when the edge of a HSYNC pulse does not coincide with the edge of the VSYNC pulse.

Another embodiment may assign different values to unused bit(s) in other packets depending on whether the edge of the HSYNC pulse coincides with the edge of the VSYNC pulse. Other embodiments may assign different values to a combination of unused bit(s) in a plurality of packets. Still other embodiments may set unused bit(s) in one or more packets to one or more values when the HSYNC pulse coincides with the edge of a VSYNC pulse, and may set different bit(s) in the same or different packet(s) to the same or different value(s), when the two pulses do not coincide.

Once the unused bit(s) have been encoded in the VSS, VSE, and/or other packet(s) to distinguish between the start of HSYNC pulses coinciding with the edge of VSYNC pulses, the signal processing and encoding procedure may continue as indicated in step 96 by returning to step 92 to check whether the next portion of the video signal contains the start or end of a VSYNC pulse and/or continuing to encode the video signal into DSI packets.

FIG. 9a shows a DSI Transmitter 920 in an embodiment with a DSI Encoder 912 modified to encode packets in different embodiments as previously described. DSI transmitter 920 may process an interlaced video signal in an embodiment by generating a clock 909 from an interlaced video clock signal 901, which is transformed into DSI Clock Out packets 916 on clock lane 913. Data from the I2C Bus 902, which is used to communicate with circuit boards in peripheral devices may be recorded in register map 910. Video data 903, HSYNC signal 904, and VSYNC signal 905 from the interlaced input video signal may also be processed using video processing 911.

The DSI Encoder 912 may then use data from the register map 910 and video processing 911 to generate encoded DSI packets. These encoded DSI packets may include the new VSS2 or VSE2 packets previously described, or they may include existing DSI packets, such VSS or VSE packets, whose unused bits, such as the Data0 bit of a VSYNC packet, are encoded to distinguish between cases where the edge of a VSYNC pulse coincides with the edge of a HSYNC pulse from other situations where it does not.

The encoded packets may then be transmitted through the data lanes 914 to 915. When more than one data lane is used, the lanes may be used in parallel, with sequential bytes traveling on the next lane, resulting in a plurality of data outs 917 to 918.

In other embodiments, a DSI receiver may be used that reverses the functionality of the DSI transmitter 920 to regenerate interlaced video signals from encoded DSI packets.

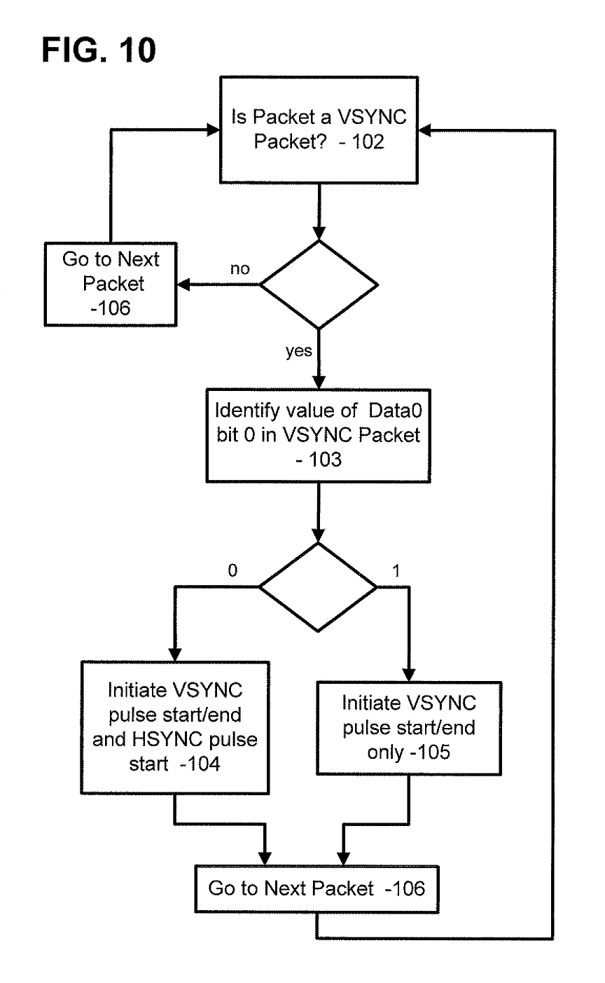

FIG. 10 shows an embodiment for decoding modified DSI packets to determine whether the edge of a VSYNC pulse coincides with the edge of a HSYNC pulse. During packet decoding process, an embodiment in step 102 may check whether the packet being decoded is a VSYNC packet, such as a VSS or VSE packet.

If the packet is not a VSYNC packet, the packet may be decoded and an embodiment may move on to the next packet, as shown in step 106, returning to step 102 to check if the next packet is a VSYNC packet.

When a packet is a VSYNC packet, such as a VSS or VSE packet, the unused bit(s) that may have been encoded in the VSYNC and/or other packet(s) to distinguish between the edge of HSYNC pulses coinciding with the edge of VSYNC pulses may be checked. When a check of these bit(s) indicates that the edge of the VSYNC pulse coincides with the edge of the HSYNC pulse, an HSYNC pulse may be simultaneously started with either the start or end of a VSYNC pulse depending on whether the VSYNC packet is a VSS or VSE packet. The HSYNC pulse may continue to remain active until the next HSE packet indicates the end of the HSYNC pulse. When a check of these bit(s) indicates that the edge the VSYNC pulse does not coincide with the start of the HSYNC pulse, only the VSYNC pulse may be started or ended depending on the type of VSYNC packet, such as VSS or VSE.

For example, the embodiment in FIG. 10 shows the decoding procedure for FIG. 9 when the Data0 bit 0 in the VSYNC packet is used to distinguish between HSYNC pulse starts coinciding and not coinciding with the start or end of VSYNC pulses. In step 103, the value of the Data0 bit 0 in the VSYNC packet is identified.

When the Data0 bit 0 is equal to 0, a HSYNC pulse is started simultaneously with the start or end of a VSYNC pulse, depending on whether the VSYNC packet is a VSS or VSE packet, as indicated in step 104.

When the Data0 bit 0 is equal to 1, only the VSYNC pulse is started or ended, depending on whether the VSYNC packet is a VSS or VSE packet, as indicated in step 105.

In step 106, an embodiment may move on to the next packet, returning to step 102 to check if the next packet is a VSYNC packet.

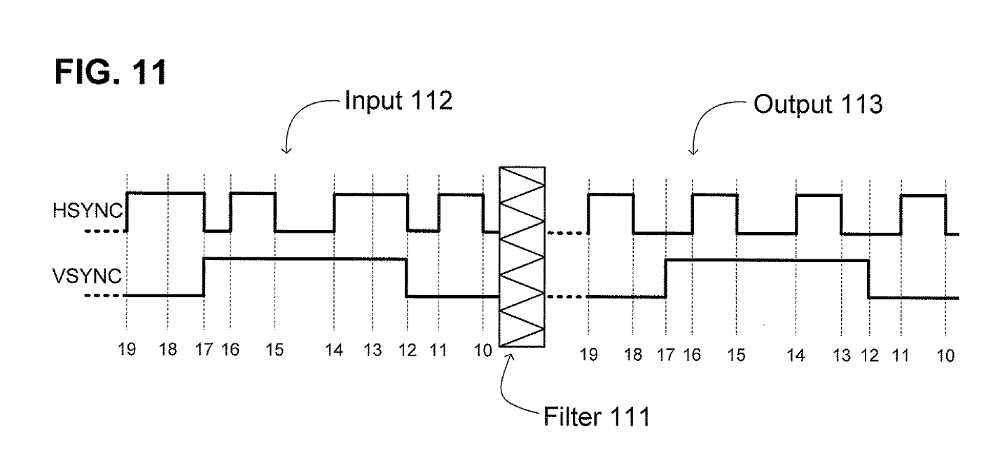

FIG. 11 shows another embodiment of the invention using a filter 111 to resynchronize the HSYNC waveform. Since a HSYNC signal instructs a monitor or display to stop drawing the current horizontal line, and start drawing the next line, the frequency or number of signal cycles per second may remain constant when multiple horizontal lines are being drawing together on a display. The filter 111 may detect frequency variations through a variety of methods. For example, valid HSYNC frequency(ies) may be provided to the filter; deviations may then be classified as acceptable or unacceptable variations. Alternatively, the filter may compare the period of two or more cycles to determine the proper frequency, or the filter may use a pattern detection algorithm or logic to determine the proper frequency. In sum, any technique for detecting frequency variations from the proper HSYNC frequency may be used.

Once an variation is detected it may be corrected by resynchronizing the HSYNC signal to the proper frequency. The HSYNC and VSYNC signal inputs 112 shown in FIG. 11 are the same as those obtained from decoding DSI packets corresponding to interlaced video frame type B, as also shown in FIG. 4. As discussed previously, HSYNC pulses in type B frames are prematurely started at times 12 and 17, as shown in FIG. 4, because DSI specifications require that an HSYNC pulse be started whenever a VSYNC pulse is started or ended, resulting in error regions 41 and 42. As a result, both the frequencies and periods of the input 112 HSYNC pulses active between times 10 to 11 and times 15 to 16 will be different than the frequencies and periods of the HSYNC pulses active between times 12 to 14 and 17 to 19.

In an embodiment, the filter 111 may be configured to recognize the frequency corresponding to the HSYNC pulses active between times 10 to 11 and 15 to 16 as the proper frequency. In this embodiment, the filter 111 may delay the start of the HSYNC pulse at time 12, as shown in the input HSYNC signal 112, to time 13, as shown in the output HSYNC signal 113 in order to maintain the proper HSYNC frequency synchronization in the output signal 113. Similarly, the filter 111 may also delay the start of the HSYNC pulse at time 17, as shown in the input HSYNC signal 112, to time 18, as shown in the output HSYNC signal 113 in order to maintain the proper HSYNC frequency synchronization in the output signal 113.

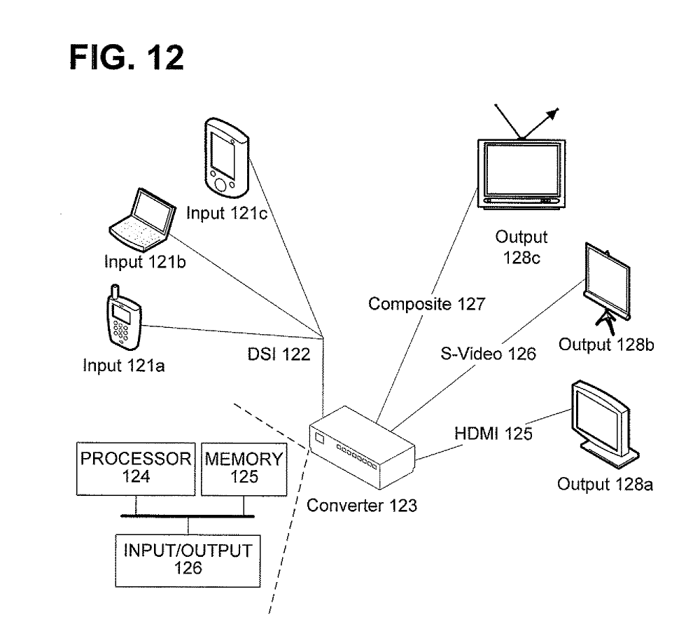

FIG. 12 shows a converter 123 containing filter 111 in an embodiment. One or more input devices 121, shown as input devices 121a, b, and c, may be communicatively connected to converter 123. An input device 121 may be any type of electronic and/or computing device capable of using DSI 122 to send image data to the converter 123. Examples of input devices include, but are not limited to, mobile phones, personal digital assistants, computers including laptops, portable music players, portable video players, televisions, and cameras. Each input device 121 may be communicatively connected to converter 123 by any means or method enabling the transfer of image data between an input device 121 and the converter 123.

In an embodiment, converter 123 may receive image data from an input device 121 through DSI 122. The converted 123 may decode the DSI packets and generate an interlaced and/or progressive video signal. The interlaced video signal may then passed through the filter in order to maintain the proper HSYNC frequency synchronization in the interlaced video signal and eliminate HSYNC errors 41 and 42.

The filtered interlaced video signal may then be transmitted to one or more output devices 128, shown as 128a, b, and c, by the converter 123 using composite video 127, S-Video 126, HDMI 125, or other transmission interfaces. Examples of other video transmission interfaces include, but are not limited to, Radio Frequency, coaxial cable, SCART, component video, and D-Terminal. Any type of transmission interface adapted to transmit an interlaced video signal may be used.

An output device 128 may be any type of electronic and/or computing device adapted to display interlaced video. Examples of output devices 128 include, but are not limited to televisions, computer monitors, LCDs, CRTs, projectors, LEDs, organic light emitting diodes (OLEDs) and light emitting polymers (LEPs). Input and/or output devices may also be mobile terminals. A “Mobile Terminal” means a mobile or handheld device that incorporates as a standard function wireless voice communication capability according to a telecommunications standard adopted either by the International Telecommunication Union (ITU) or other SDO as agreed by Mobile Industry Processing Interface Alliance.

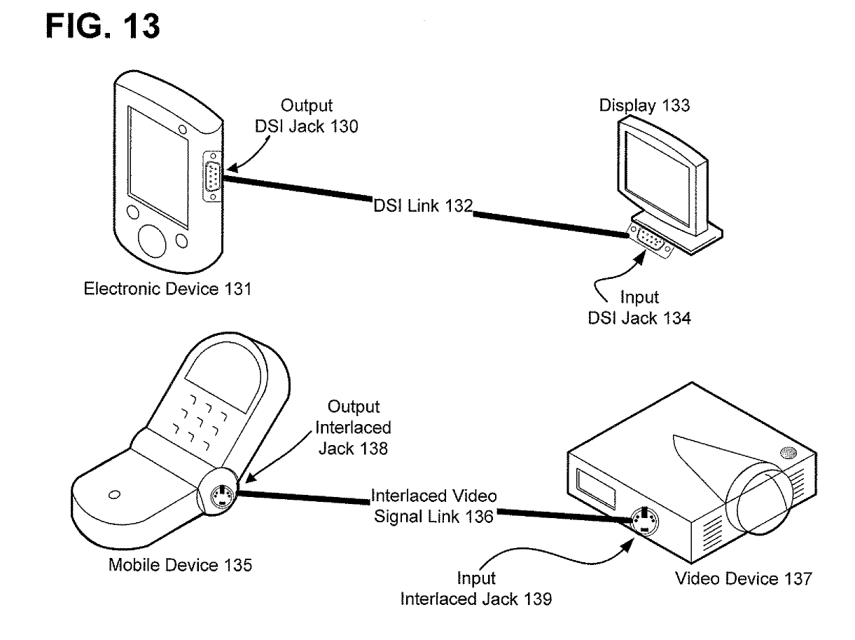

In other embodiments, the filter 111 may be a part of or affixed to different electronic and/or devices. FIG. 13 shows embodiments where a filter 111 is incorporated in different electronic devices. In the upper portion of the FIG. 13, electronic device 131 send DSI video signals through DSI output jack 130 to display 133 containing DSI input jack 134 and filter 111 through DSI Link 132. When display 133 regenerates an interlaced video signal from the DSI packets received through DSI link 132, the regenerated interlaced video signal may sent through the filter 111 in the display 133 to maintain the proper HSYNC frequency synchronization.

In another embodiment shown in the lower portion of FIG. 13, the filter 111 may be part of or affixed to a mobile device 135 containing an interlaced output jack 138, such as a S-Video Interface Jack, so a interlaced video signal regenerated from DSI packets in the mobile device 135 can be sent through the filter 111 in the mobile device 135 to the interlaced output jack 138 in order to maintain the proper HSYNC frequency synchronization. The regenerated interlaced video signal may then be sent to the interlaced input jack 139 of a video device 137, through an interlaced video signal link 136. Affixed or including the filter 111 as part of a device, such as mobile device 135, may be useful, for example, when the device has an interface used for transmitting an interlaced video signal, such as a component out, composite out, or HDMI port.

Converter 123, input device(s) 121, and/or output device(s) may contain a processor 124, memory 125, and an input/output interface 126, all of which may be interconnected via a system bus. In different embodiments, memory 125 may contain different components for retrieving, presenting, changing, and saving data. Memory 125 may include a variety of memory devices, for example, Dynamic Random Access Memory (DRAM), Static RAM (SRAM), flash memory, cache memory, and other memory devices. Additionally, for example, memory 125 and processor(s) 124 may be distributed across several different computers that collectively comprise a system.

Processor 124 may perform computation and control functions of a system and comprises a suitable central processing unit (CPU). Processor 124 may comprise a single integrated circuit, such as a microprocessor, or may comprise any suitable number of integrated circuit devices and/or circuit boards working in cooperation to accomplish the functions of a processor. Processor 124 may execute computer programs within memory 125.

The embodiment shown in FIG. 12 may also be combined with other embodiments of the invention described herein. For example, in some embodiments, instead of the converter 123 containing the filter 111, some of the input devices 121 may be configured to encode an unused bit(s) in a DSI packet(s) to distinguish situations when a VSYNC start or end coincides with a HSYNC start from those situations when a VSYNC start or end does not coincide with a HSYNC start. The converter 123 may then be configured to read the same encoded bit(s) to identify whether a HSYNC start should coincide with a VSYNC start or end when generating the interlaced video signal to be transmitted to the output device(s) 128 using one or more transmission interface(s) as previously discussed.

In other embodiments, some of the input devices 121 may be configured to insert a new VSYNC start (VSS2) or end (VSE2) packet when the start (VSS2) or end (VSE2) of a VSYNC pulse does not coincide with the start of a HSYNC pulse. The converter 123 may then be configured to process the DSI packets as per the specification. When the converter 123 processes a VSS2 and/or VSE2 packet(s), which may not be defined by the specification, the converter 123 may be configured to start a VSYNC pulse (VSS2) or end a VSYNC pulse (VSE2) without changing any aspect of the HSYNC signal. The converter 123 may then transmit the generated interlaced video signal to the output device(s) 128 using one more transmission interface(s) as previously discussed.

Note that while embodiments of the present invention are described in the context of fully functional systems, modules or components of the present invention are capable of being distributed in a variety of forms across a plurality of systems For example, the filter 111, may be a stand alone unit that is not part of the converter 123 in some embodiments. Embodiments consistent with the invention may also include one or more programs or program modules on different computing systems running separately and independently of each other, while in their entirety being capable of performing functions described herein, such as encoding or decoding of DSI packets. These programs or program modules may be contained on signal bearing media that may include: recordable type media such as floppy disks and CD ROMS, and transmission type media such as digital and analog communication links, including wireless communication links.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

We claim:

1. A method comprising:
encoding an interlaced video signal in packets pursuant to a display serial interface specification;
upon reaching a portion of the interlaced video signal containing an edge of a VSYNC pulse, identifying whether the pulse edge coincides with a start of a HSYNC pulse; and
if so, coding the VSYNC edge in a packet of a first type, the first type indicating that the pulse edge coincides with the HSYNC pulse, and
otherwise, coding the VSYNC edge in a packet of a second type, the second type indicating that the pulse edge does not coincide with an HSYNC pulse.

2. The method of claim 1, further comprising identifying whether the edge of the VSYNC pulse is a start edge of the VSYNC pulse; and
if so, further coding the VSYNC edge to indicate the start edge of the VSYNC pulse, and
otherwise not coding the VSYNC edge to indicate the start edge of the VSYNC pulse.

3. The method of claim 1, further comprising identifying whether the edge of the VSYNC pulse is an end edge of the VSYNC pulse; and
if so, further coding the VSYNC edge to indicate the end edge of the VSYNC pulse, and
otherwise not coding the VSYNC edge to indicate the end edge of the VSYNC pulse.

4. The method of claim 1, where the first type of packet comprises a format specified by Display Serial Interface Specification Version v1.01.00.

5. The method of claim 4, where the first type of packet comprises a VSYNC packet.

6. The method of claim 1, where the second type of packet comprises a format specified by Display Serial Interface Specification Version v1.01.00.

7. The method of claim 6, where the second type of packet comprises a VSYNC packet.

8. The method of claim 1, where the second type of packet does not comprise a format specified by Display Serial Interface Specification Version v1.01.00.

9. The method of claim 4, where second type of packet comprises the same format as the first type of packet, the first type of packet indicating that the pulse edge coincides with the HSYNC pulse by setting a bit in the first type of packet to a first state, the second type of packet indicating that the pulse edge does not coincide with an HSYNC pulse by setting a bit in the second type of packet to a second state.

10. The method of claim 9, where the bit in the first type of packet set to the first state is the same bit in the second type of packet set to the second state.

11. The method of claim 1, where coding the VSYNC edge comprises:
setting a first bit to a first state in a first packet to designate the first packet as the first type; and
setting a second bit to a second state in a second packet to designate the second packet as the second type.

12. The method of claim 11, where the first bit and the second bit are the same bit.

13. The method of claim 11, where the first state and the second state are the same state.

14. The method of claim 11, where the first packet and the second packet are the same packet.

15. The method of claim 1, where coding the VSYNC edge comprises:
setting a first bit to a first state in a first packet to designate a third packet as the first type;
setting a second bit to a second state in a second packet to designate a fourth packet as the second type.

16. The method of claim 15, where the third packet and the fourth packet are the same packet.

17. The method of claim 5, where the VSYNC edge is coded in at least one of fields Data0 and Data1 of the VSYNC packet.

18. The method of claim 17, where a bit in the field Data0 is set to a first state when the edge of the VSYNC pulse coincides with the start of the HSYNC pulse and the bit is set to a second state when the edge of the VSYNC pulse does not coincide with the start of the HSYNC pulse.

19. A method comprising:
encoding an interlaced video signal in packets pursuant to a display serial interface specification, the encoded packets including a means for distinguishing a portion of the signal where an edge a VSYNC pulse coincides with a start of a HSYNC pulse from another portion of the signal where the edge of the VSYNC pulse does not coincide with the start of the HSYNC pulse.

20. A method comprising:
decoding packets comprising an interlaced video signal encoded in packets pursuant to a display serial interface specification to regenerate the interlaced video signal, at least one of the packets distinguishing a portion of the interlaced video signal where an edge of a VSYNC pulse coincides with a start of a HSYNC pulse from a portion of the interlaced video signal where the edge of the VSYNC pulse does not coincide with a start of the HSYNC pulse;
upon reaching the at least one packet distinguishing the portion of the interlaced video signal, identifying from the at least one packet whether the edge of the VSYNC pulse coincides with the start of the HSYNC pulse; and
when the edge of the VSYNC pulse coincides with the start of the HSYNC pulse, generating the edge of the VSYNC pulse to coincide with the start of the HSYNC pulse in the interlaced video signal, and
otherwise, generating the edge of the VSYNC pulse without changing the HSYNC signal.

21. A method comprising:
receiving packets comprising an interlaced video signal encoded in the packets pursuant to a display serial interface specification, at least one of the packets comprising a means for distinguishing a portion of the interlaced video signal where an edge of a VSYNC pulse coincides with a start of a HSYNC pulse from another portion of the signal where the edge of the VSYNC pulse does not coincide with the start of the HSYNC pulse; and
regenerating the interlaced video signal by decoding the packets, the decoding comprising a means for distinguishing the portion of the interlaced video signal where the edge of the VSYNC pulse coincides with the start of the HSYNC pulse from another portion of the signal where the edge of the VSYNC pulse does not coincide with the start of the HSYNC pulse in the at least one encoded packet.

22. A method, comprising:
processing a decoded interlaced video signal, the decoded signal being decoded from packets pursuant to a display serial interface specification, the packets containing an encoded interlaced video signal, the encoded interlaced video signal being encoded into the packets pursuant to the display serial interface specification;
monitoring the frequency of a HSYNC signal of the decoded interlaced video signal during the processing of the decoded interlaced video signal; and
upon detecting a variation in the frequency of the HSYNC signal, resynchronizing the HSYNC signal to maintain signal continuity.

23. The method of claim 23, where the frequency of the monitored HSYNC signal is compared to a list of one or more frequency(ies) to detect the variation in the frequency of the monitored signal.

24. The method of claim 24, where, upon detecting a variation in the frequency, the HSYNC signal is resynchronized to another monitored frequency of the HSYNC signal contained on the list of frequency(ies).

25. The method of claim 23, where the frequency monitoring of the HSYNC signal compares the periods of a plurality of HSYNC signal cycles to detect frequency variations.

26. The method of claim 26, where the signal cycles with longer periods are considered frequency variations that are resynchronized to the signal cycles with shorter periods.

27. The method of claim 23, where a pattern detection algorithm is used to detect frequency variations.

28. A transmitter comprising a DSI encoder operative to:
encode an interlaced video signal in packets pursuant to a display serial interface specification;
upon reaching a portion of the interlaced video signal containing an edge of a VSYNC pulse, identify whether the pulse edge coincides with a start of a HSYNC pulse; and
if so, code the VSYNC edge in a packet of a first type, the first type indicating that the pulse edge coincides with the HSYNC pulse, and
otherwise, code the VSYNC edge in a packet of a second type, the second type indicating that the pulse edge does not coincide with an HSYNC pulse.

29. A receiver comprising a DSI decoder operative to:
decode packets comprising an interlaced video signal encoded in packets pursuant to a display serial interface specification to regenerate the interlaced video signal, at least one of the packets distinguishing a portion of the interlaced video signal where an edge of a VSYNC pulse coincides with a start of a HSYNC pulse from a portion of the interlaced video signal where the edge of the VSYNC pulse does not coincide with a start of the HSYNC pulse;
upon reaching the at least one packet distinguishing the portions of the interlaced video signal, identify from the at least one packet whether the edge of the VSYNC pulse coincides with the start of the HSYNC pulse; and
when the edge of the VSYNC pulse coincides with the start of the HSYNC pulse, regenerate the edge of the VSYNC pulse to coincide with the start of the HSYNC pulse in the interlaced video signal, and
otherwise, generate the edge of the VSYNC pulse without changing the HSYNC pulse.
